(19) United States
(12) Patent Application Publication
(10) Pub. No.: US 2022/0042721 A1
(43) Pub. Date: Feb. 10, 2022

(54) SYSTEM FOR POWER GENERATION FROM RENEWABLE ENERGY, AND RELATED LONGITUDINAL FINNED HEAT EXCHANGERS AND METHODS

(71) Applicant: Battelle Energy Alliance, LLC, Idaho Falls, ID (US)

(72) Inventor: Robert K. Podgorney, Idaho Falls, ID (US)

(21) Appl. No.: 17/444,302

(22) Filed: Aug. 3, 2021

Related U.S. Application Data
(60) Provisional application No. 62/706,285, filed on Aug. 7, 2020.

(51) Int. Cl. F24T 10/17; F28D 7/12; F28F 1/16

(52) U.S. Cl. CPC F24T 10/17; F28D 7/12; F28F 2250/106; F28F 2215/06; F28F 1/16

(57) ABSTRACT

A system for power generation from renewable energy, comprising a heat exchanger within a subterranean formation. The heat exchanger comprises a casing at an upper portion of the wellbore, a tubular member extending through the casing to a lower portion of the wellbore, and fins in fluid communication with the casing and with the tubular member, the fins each comprising a volume defined by surfaces of the subterranean formation and configured to receive a fluid from the casing. Related longitudinal finned heat exchangers and methods of storing thermal energy within a subterranean formation are also disclosed.

### CROSS-REFERENCE TO RELATED APPLICATION

This application claims the benefit under 35 U.S.C. § 119(e) of U.S. Provisional Patent Application Ser. No. 62/706,285, filed Aug. 7, 2020, the disclosure of which is hereby incorporated herein in its entirety by this reference.

### STATEMENT REGARDING FEDERALLY SPONSORED RESEARCH OR DEVELOPMENT

This invention was made with government support under Contract Number DE-AC07-05-ID14517 awarded by the United States Department of Energy. The government has certain rights in the invention.

### FIELD

Embodiments of the disclosure relate generally to heat exchangers and systems for storing energy in, or recovering energy from, a subterranean formation, and to related methods. More particularly, embodiments of the disclosure relate to heat exchangers configured to facilitate subsurface storage or recovery of thermal energy and to provide a fluid at a substantially constant temperature to a power generation system, and to related methods.

### BACKGROUND

As the global population increases, the demand for energy is expected to continue to increase. Methods of energy production include coal gas filed power plants, natural gas energy production, renewable energy (e.g., wind, wood, solar, hydroelectric, biofuels), and nuclear power generation, among other methods.

Renewable energy sources are of increasing interest and importance since they do not contribute to the net emissions of greenhouse gases into the atmosphere and are generally considered safer than other forms of energy generation (e.g., nuclear power). However, unlike power generation from sources such as fossil fuels or nuclear power, renewable energy sources such as solar, wind, and hydroelectric power suffer from daily and seasonal fluctuations in the generated power. For example, power from wind generation may be subject to ambient atmospheric conditions and the amount (e.g., velocity) of wind at a particular given time. The amount of power generated from solar sources is proportional to the amount of sunlight to which solar panels are exposed. Thus, solar power generation exhibits fluctuations based on the time of day and amount of cloud cover, among other things. Further, the peak hours for energy generation by renewable sources often does not match the power demand curve (e.g., the peak energy generation by renewable sources does not match the peak power demand curve). In other words, the fluctuations in energy generation by renewable sources may not match the fluctuations in energy demand.

### BRIEF SUMMARY

In accordance with one embodiment described herein, a system for power generation from renewable energy, comprising a heat exchanger within a subterranean formation. The heat exchanger comprises a casing at an upper portion of the wellbore, a tubular member extending through the casing to a lower portion of the wellbore, and fins in fluid communication with the casing and with the tubular member, each of the fins comprising a volume defined by surfaces of the subterranean formation and configured to receive a fluid from the casing.

In other embodiments, a longitudinal finned heat exchanger comprises a casing including one or more channels extending therethrough, the one or more channels configured to receive a fluid from above a surface of the Earth; a tubular member vertically extending through the casing and through a subterranean formation; and longitudinal fins extending through the subterranean formation, an upper portion of each longitudinal fin of the longitudinal fins in fluid communication with a channel of the one or more channels of the casing and a lower portion of each longitudinal fin of the longitudinal fins in fluid communication with the tubular member, each longitudinal fin of the longitudinal fins defined by surfaces of the subterranean formation.

In additional embodiments, a method of storing thermal energy within a subterranean formation comprises flowing a fluid from a source to a heat exchanger within a subterranean formation. The heat exchanger comprises a plurality of fins extending through the subterranean formation, each fin defined by surfaces of the subterranean formation and defining an open volume configured for flowing another fluid within the heat exchanger. The method further comprises transferring heat between the another fluid within the fins and the subterranean formation.

### BRIEF DESCRIPTION OF THE DRAWINGS

FIG. 1 is a simplified schematic of a system for power generation, in accordance with embodiments of the disclosure;

FIG. 2 is a simplified schematic of a heat exchanger, in accordance with embodiments of the disclosure; and

FIG. 3 is a simplified top down view of a casing, in accordance with embodiments of the disclosure.

### DETAILED DESCRIPTION

The following description provides specific details, such as material types, dimensions, and processing conditions in order to provide a thorough description of embodiments of the disclosure. However, a person of ordinary skill in the art will understand that the embodiments of the disclosure may be practiced without employing these specific details. Indeed, the embodiments of the disclosure may be practiced in conjunction with conventional fabrication techniques employed in the industry. In addition, the description provided below does not form a complete process flow, apparatus, or system for forming a heat exchanger within a subterranean formation or a system including the heat exchanger. Only those process acts and structures necessary to understand the embodiments of the disclosure are described in detail below. Additional acts to form a final structure including the materials and methods described herein may be performed by conventional techniques. Also note, any drawings accompanying the present application are for illustrative purposes only, and are thus not drawn to scale. Additionally, elements common between figures may retain the same numerical designation.

As used herein, the term “substantially” in reference to a given parameter, property, or condition means and includes to a degree that one of ordinary skill in the art would understand that the given parameter, property, or condition is met with a degree of variance, such as within acceptable tolerances. By way of example, depending on the particular parameter, property, or condition that is substantially met, the parameter, property, or condition may be at least 90.0 percent met, at least 95.0 percent met, at least 99.0 percent met, at least 99.9 percent met, or even 100.0 percent met.

According to methods described herein, a geologic formation (e.g., a subterranean formation) (also referred to herein as a “formation”) may be used to store energy (e.g., thermal energy) in the formation, recover energy (e.g., thermal energy) from the formation, or both. A heat exchanger (e.g., a first heat exchanger) may be coupled to a heat source and configured to exchange heat between a first fluid from the heat source and a second fluid within the formation. The formation may include a heat exchanger (e.g., a longitudinal finned heat exchanger (LFHE); a second heat exchanger; an additional heat exchanger), which second heat exchanger may be in the formation and configured to facilitate heat transfer between the second fluid in the formation and the formation as the second fluid circulates between the first heat exchanger and the second heat exchanger. The heat exchanger in the formation may comprise a wellbore configured to circulate the second fluid introduced into the wellbore at the surface of the Earth from the heat exchanger at the surface. The second fluid may circulate through the heat exchanger at the surface and the heat exchanger in the formation. The second fluid may flow through channels in the casing to so-called “fins” of the heat exchanger fluidly coupled to the channels of the casing. The fins may comprise cavities or voids formed in the formation and defined by surfaces of the formation. Stated another way, the heat exchanger may comprise surfaces of the formation that define the fins through which the second fluid flows. The second fluid flows from the heat exchanger at the surface of the Earth to the top of the wellbore, from the top of the wellbore to the bottom of the wellbore (such as by gravity) through the fins and from the fins to tubing (e.g., production tubing, a production casing) at the bottom of the wellbore, and back to the heat exchanger at the surface of the Earth through the tubing. The second fluid exiting the wellbore through the tubing may be referred to as a “produced fluid.” The second fluid may be pumped to the heat exchanger at the surface where the second fluid may be used in one or more processes, the second fluid exhibiting a substantially uniform temperature, relative to the temperature of the first fluid from the heat source. In some embodiments, the second fluid is used in another heat exchange process to heat a third fluid of a power generation system. In some such embodiments, the second fluid exiting the wellbore may be used to provide heat to a third fluid circulating in one or more power generation systems for generating power. The power generation system may be in electrical communication with an electrical grid and may be configured to stabilize the electrical grid by providing stable baseload power generation. The cooled second fluid is returned to the formation where it exchanges heat with the formation and the cycle is repeated.

As the second fluid flows through the fins to the bottom of the wellbore, heat may be transferred between the second fluid and the formation, stabilizing the temperature of the second fluid exiting the formation. In some embodiments, the fins of the heat exchanger are configured (e.g., sized and shaped) to hold a desired volume of the second fluid, which may be equivalent to (e.g., correspond to) a desired amount of power that may be generated from the second fluid by the power generation system, based on the temperature of the second fluid. In some embodiments, the heat exchanger may be configured to store thermal energy generated from a renewable energy source to be converted to power at a relatively uniform output. In some such embodiments, the heat exchanger may comprise a thermal battery that stores the thermal energy of the second fluid within the formation.

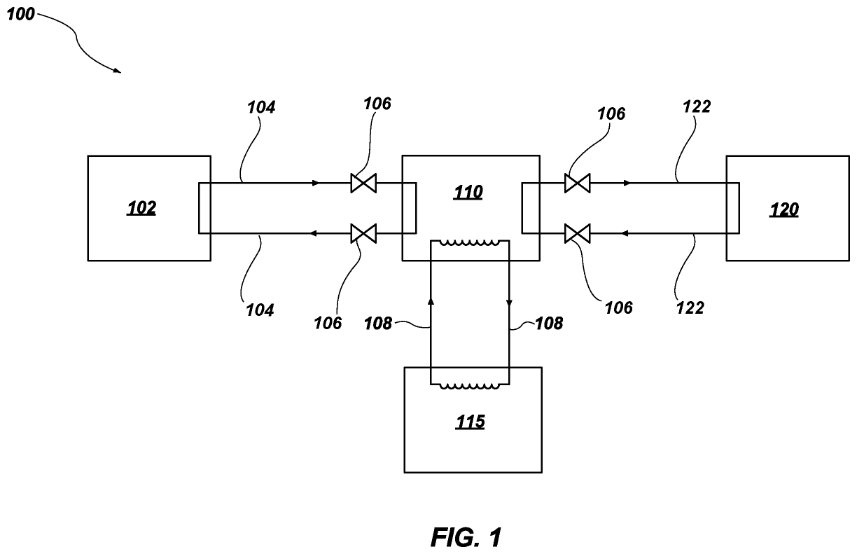

FIG. 1 is a simplified schematic of a system 100 for power generation, in accordance with embodiments of the disclosure. The system 100 includes a source 102 that provides a first fluid 104 (e.g., a thermal transfer fluid) having a first temperature to a heat exchanger 110 in fluid communication with the source 102. The heat exchanger 110 is configured to transfer heat between the first fluid 104 and a second fluid 108 circulating from an additional heat exchanger 115. The heat exchanger 110 may be configured to transfer energy between the first fluid 104 and the second fluid 108 to provide the second fluid 108 having a second temperature different than the first temperature. As will be described herein, the additional heat exchanger 115 may be located within a formation, such as a subterranean formation, and may comprise or be defined by surfaces of the formation.

The system 100 further comprises a power generation system 120 in fluid communication with the heat exchanger 110. The heat exchanger 110 may be configured to transfer energy between the second fluid 108 and a third fluid 122 to provide the third fluid 122 having a third temperature different than the first temperature of the first fluid 104 and/or the second temperature of the second fluid 108. The system 100 may include valves 106 for selectively controlling a flow rate of the each of the first fluid 104, the second fluid 108, and the third fluid 122 within the system 100. Accordingly, in some embodiments, heat may be transferred between the first fluid 104 and the second fluid 108 within the heat exchanger 110. As will be described herein, the second fluid 108 may circulate between the heat exchanger 110 and the additional heat exchanger 115 which may be sized, shaped, and configured to maintain the second fluid 108 at a substantially constant second temperature.

In some embodiments, the valves 106 are positioned to substantially stop the flow of the first fluid 104 in the heat exchanger 110 and introduce the third fluid 122 into the heat exchanger 110 and facilitate transfer of heat between the second fluid 108 and the third fluid 122 within the heat exchanger 110. The third fluid 122 may be used to generate power in the power generation system 120. In other embodiments, the second fluid 108 and the third fluid 122 may be configured to flow through a different heat exchanger than the heat exchanger 110 to facilitate transfer of heat between the second fluid 108 and the third fluid 122. In other words, in some embodiments, the first fluid 104 and the third fluid 122 may not be configured to flow through the same heat exchanger 110.

In some embodiments, the first fluid 104, the second fluid 108, and the third fluid 122 comprise the same material composition. In some embodiments, each of the first fluid 104, the second fluid 108, and the third fluid 122 comprise water. In other embodiments, the first fluid 104, the second fluid 108, and the third fluid 122 individually comprise a different material composition.

The source 102 may comprise an intermittent renewable energy generator. The source 102 may include, for example, a concentrated solar power (CSP) farm (e.g., a concentrated solar collection system), a wind power plant including one or more wind turbines, or another form of renewable energy. In other embodiments, the source 102 comprises a power plant (e.g., a coal-fired power plant, a natural gas power plant, a nuclear power plant), a refinery, or other industrial process that generates one or more heated fluids (e.g., streams of the heated fluids from which waste heat may be recovered). In some embodiments, the source 102 is configured to generate the first fluid 104 having the first temperature. In some embodiments, the first temperature of the first fluid 104 may exhibit fluctuations during use and operation of the source 102. By way of non-limiting example, where the source 102 comprises a concentrated solar collection system, the first fluid 104 may exhibit fluctuations in the first temperature based on the amount of sunlight available, which may fluctuate based on, for example, cloud cover time of day, and season of the year.

The heat exchanger 110 may be configured to receive the first fluid 104 at the first temperature and facilitate thermal transfer between the first fluid 104 and the second fluid 108. The second fluid 108 may be configured to circulate between the heat exchanger 110 and the through the additional heat exchanger 115 to form the second fluid 108 exhibiting a relatively stable second temperature. In some embodiments, the relatively stable temperature of the second fluid 108 may exhibit variations of less than about 25° C., such as less than about 20° C., less than about 15° C., less than about 10° C., or less than about 5° C. over the course of a day. As will be described herein, in some embodiments, the heat exchanger 110 may be configured to receive the first fluid 104 exhibiting varying temperatures during use and operation of the source 102 and transfer heat to the second fluid 108, which circulates through the additional heat exchanger 115 to generate the second fluid 108 having a relatively stable second temperature. The relatively stable second temperature of the second fluid 108 may be beneficial when the second fluid 108 is used as a heat source for transferring heat to the third fluid 122 of the power generation system 120. In some embodiments, the volume of the additional heat exchanger 115 is sufficient such that the second fluid 108 leaving the additional heat exchanger 115 exhibits a relatively stable temperature. In some embodiments, the second temperature is greater than the first temperature. In other embodiments, the second temperature is less than the first temperature.

The power generation system 120 may be configured to receive the third fluid 122 and generate power from the third fluid 122. The power generation system 120 may comprise an organic Rankine cycle (ORC) system configured to generate electricity. In some embodiments, the power generation system 120 comprises a binary ORC system. In some such embodiments, the third fluid 122 may heat and vaporize another fluid exhibiting a relatively lower boiling point and higher vapor pressure than the third fluid 122. The vaporized another fluid may be used to generate electricity from a turbine, as known in the art.

In some embodiments, the power generation system 120 is electrically coupled to an electrical grid. The power generation system 120 may be sized and configured to generate from about 10 MW to about 50 MW power, such as from about 10 MW to about 20 MW, from about 20 MW to about 30 MW, from about 30 MW to about 40 MW, or from about 40 MW to about 50 MW power. However, the disclosure is not so limited and the power generation system 120 may be configured to generate a different amount of power than those described.

In some embodiments, the heat exchanger 110 may be sized and configured to provide a sufficient volume and flowrate of the third fluid 122 to the power generation system 120 to generate the desired amount of power. In some embodiments, the additional heat exchanger 115 may be sized and configured to provide and contain a sufficient volume the second fluid 108 such that the temperature of the second fluid 108 leaving the additional heat exchanger 115 is relatively constant.

In some embodiments and due to the relatively stable temperature of the second fluid 108 leaving the additional heat exchanger 115, the system 100 may be configured to generate a relatively stable power output even though the temperature of the first fluid 104 may exhibit a fluctuating temperature. Stated another way, the system 100 may be configured to generate a baseload power, despite the varying temperature of the first fluid 104 provided by the source 102 comprising, for example, a renewable energy source.

As described above, the additional heat exchanger 115 may provide the second fluid 108 for transfer of heat with the third fluid 122 used in the power generation system 120 at a relatively stable temperature. The relatively stable temperature of the third fluid 122 may facilitate a corresponding relatively stable (e.g., substantially uniform) rate of power generation by the power generation system 120. Accordingly, in some embodiments, the system 100 may be configured to generate power at a relatively stable rate even if the source 102 exhibits variations in operation, such as daily or seasonal (e.g., monthly, annual) variations in availability (e.g., output).

In some embodiments, the additional heat exchanger 115 may be sized and configured to store the second liquid 108 until sufficient demand for power (e.g., from the power generation system 120) is required. In some such embodiments, the additional heat exchanger 115 may be referred to as a so-called “battery” or a “thermal battery” for storage of thermal energy that may be subsequently converted to electrical energy by the power generation system 120.

Accordingly, in some embodiments, the heat exchanger 110 may be configured to facilitate heat transfer between the first fluid 104 and the second fluid 108. After a duration, the circulation of the first fluid 104 through the heat exchanger 110 may be substantially stopped and the third fluid 122 may be circulated through the heat exchanger 110 to facilitate transfer of heat between the third fluid 122 and the second fluid 108. By way of non-limiting example, in some such embodiments, the first fluid 104 and the third fluid 122 may be selectively configured to flow through one of a shell side or a tube side of a shell and tube heat exchanger and the second fluid 108 may be configured to flow through the other of the shell side or the tube side of the shell and tube heat exchanger. In other embodiments, heat may be transferred between the first fluid 104 and the second fluid 108 in a different heat exchanger in which heat is transferred between the second fluid 108 and the third fluid 122.

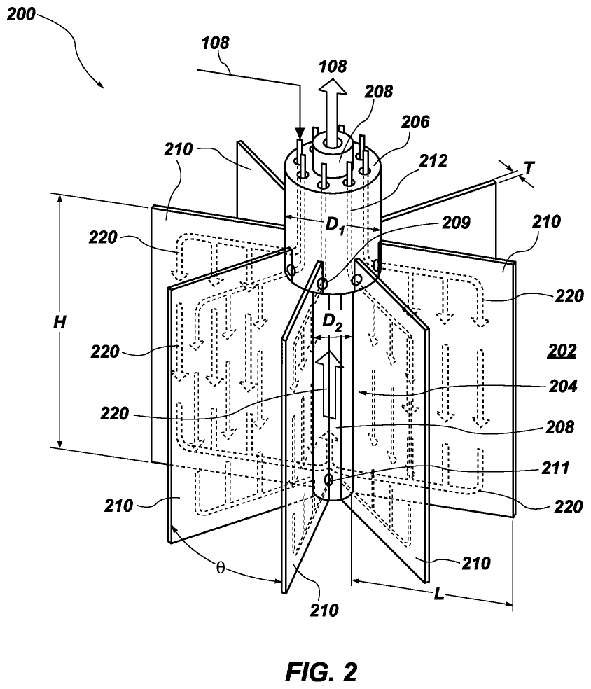

FIG. 2 is a simplified schematic of a heat exchanger 200, in accordance with embodiments of the disclosure. The heat exchanger 200 may comprise the additional heat exchanger 115 described above with reference to FIG. 1. In other words, the heat exchanger 200 may be used in the system 100 of FIG. 1.

At least a portion of the heat exchanger 200 may be located in a formation 202, such as a subterranean formation. In some embodiments, substantially all of the heat exchanger 200 is located beneath a surface of the Earth. In some embodiments, an upper surface of the heat exchanger 200 (such as an upper surface of a casing 206) may be located beneath the surface of the Earth. In some embodiments, the formation 202 may define at least a portion of the heat exchanger 200 and the heat exchanger 200 may be surrounded by the formation 202. The formation 202 may comprise a geologic formation such as, for example, one or more of limestone, shale, sandstone, carbonates, or another form of mineral rock.

The heat exchanger 200 may include a wellbore 204 extending from the surface of the Earth into the formation 202. The wellbore 204 may include the casing 206 (which may also be referred to as a “surface casing”), and a tubular member 208 (which may be referred to herein as “production tubing”) extending through the casing 206 and the wellbore 204. The casing 206 may be in fluid communication with the formation 202 through fins 210 formed in and defined by surfaces of the formation 202. The casing 206 and the tubular member 208 may not be in direct fluid communication with each other, but may be in fluid communication through the fins 210.

In some embodiments, the casing 206 includes channels 212 (illustrated in broken lines in FIG. 2 to indicate the channels 212 are within the casing 206) configured to receive the second fluid 108 from the surface of the Earth and from the heat exchanger 110 (FIG. 1) and direct the second fluid 108 to the formation 202 through the fins 210.

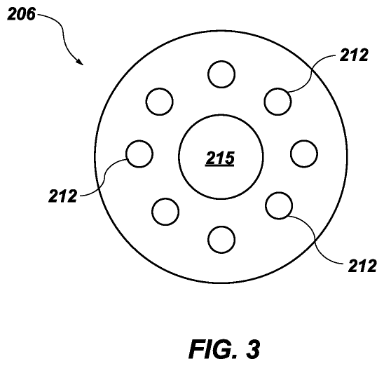

FIG. 3 is a simplified top down view of the casing 206, in accordance with embodiments of the disclosure. With combined reference to FIG. 2 and FIG. 3, the casing 206 includes the channels 212 circumferentially around the casing 206. The casing 206 may include a central aperture 215 sized and shaped to receive the tubular member 208 (FIG. 2).

With reference to FIG. 2, in some embodiments, the casing 206 includes a same number of channels 212 as a number of the fins 210. The channels 212 each terminate at a respective aperture 209 that is in fluid communication with a respective one of the fins 210. Accordingly, the fluid in the casing 206 flows through the channels 212 and to the fins 210 through the apertures 209. In some embodiments, a lower portion of the casing 206 (e.g., a portion of the casing 206 distal from the surface of the Earth and proximate the apertures 209) may be fluidly isolated from the formation 202 and the fins 210, other than through the channels 209.

The fins 210 may extend from the top of the wellbore 204 to the bottom of the wellbore 204. In some embodiments, the fins 210 extend to the casing 206 and to the bottom of the wellbore 204, such as to a lower portion of the tubular member 208. The fins 210 may be in fluid communication with the casing 206 at the top of the wellbore 204 (e.g., through the apertures 209) and may be in fluid communication with the formation 202 between the top and bottom of the wellbore 204. The fins 210 may be in fluid communication with the tubular member 208 at the bottom of the wellbore 204, such as through apertures 211 of the tubular member 208. The tubular member 208 may include apertures 211 to fluidly connect the tubular member 208 to each fin 210. In some embodiments, each fin 210 may be in fluid communication with the tubular member 208 by means of a separate aperture 211. The bottom of the wellbore 204 may be in fluid communication with the formation 202 through the tubular member 208. The second fluid 108 may exit the formation 202 out of the tubular member 208 at the surface of the Earth.

The fins 210 may be defined by surfaces of the formation 202. In some embodiments, the fins 210 of the heat exchanger 200 comprise open volumes defined by surfaces (e.g., walls) of the formation 202 and through which the second fluid 108 flows. In some such embodiments the fins 210 comprise a channel, recess, or volume through which the second fluid 108 flows and exchanges energy with the formation 202. In other words, the second fluid 108 interfaces with the surfaces of the formation 202 and exchanges heat with the formation 202 within the fins 210. Stated another way, the fins 210 may comprise voids formed within the formation 202 through which the second fluid 108 flows as the energy is transferred between the second fluid 108 and the formation 202 to generate the second fluid 108 having a substantially constant temperature. In some embodiments, the heat exchanger 200 comprises a longitudinal finned heat exchanger (e.g., a subsurface longitudinal finned heat exchanger).

The fins 210 may be sized, shaped, and configured to facilitate heat transfer between the second fluid 108 and the formation 202. In some embodiments, heat may be transferred from the formation 202 to the second fluid 108. In some such embodiments, the formation 202 may comprise a geothermal formation and the heat exchanger 200 may comprise a geothermal heat exchanger. In other embodiments, heat may be transferred from the second fluid 108 to the formation 202.

The casing 206 may be physically isolated from (e.g., out of fluid communication with) the tubular member 208. Stated another way, in some embodiments, the second fluid 108 passing through the casing 206 (e.g., through the channels 212) may not pass into the tubular member 208 without first flowing through the fins 210 and the formation 202 (e.g., without flowing to the bottom of the wellbore 204 through the fins 210). In other words, the second fluid 108 enters the casing 206 at the channels 212, which are individually in fluid communication with respective fins 210. The second fluid 108 flows through the fins 210 to the bottom of the formation 202 and is heated (or cooled) by the formation 202 to the second temperature as the second fluid 108 travels through the fins 210. At the bottom of the fins 210, the second fluid 108 passes from the fins 210 to the bottom of the tubular member 208 through the apertures 211 and flows through the tubular member 208 to the surface of the Earth. In some embodiments, the tubular member 208 includes one aperture 211 for each fin 210.

In some embodiments, the casing 206 may exhibit a relatively larger diameter D₁ than a diameter D₂ of the tubular member 208. In some embodiments, the diameter D₁ of the casing 206 may be within a range of from about 50 cm to about 120 cm, such as from about 50 cm to about 80 cm, from about 80 cm to about 100 cm, or from about 100 cm to about 120 cm. However, the disclosure is not so limited and the diameter D₁ of the casing 206 may be different than those described.

In some embodiments, the diameter D₂ of the tubular member 208 may be within a range of from about 10 cm to about 40 cm, such as from about 10 cm to about 20 cm, from about 20 cm to about 30 cm, or from about 30 cm to about 40 cm. However, the disclosure is not so limited and the diameter D₂ of the tubular member 208 may be different than those described.

In some embodiments, the fins 210 are formed in the formation 202 with abrasive jet erosion cutting. For example, a bottom hole assembly (BHA) may be used to direct a fluid comprising a particle-laden fluid at a suitable velocity at the formation 202 to form the fins 210.

Although FIG. 2 illustrates that the heat exchanger 200 includes eight (8) fins 210, the disclosure is not so limited. The heat exchanger 200 may include fewer (e.g., two (2) fins 210, three (3) fins 210, four (4) fins 210, five (5) fins 210, six (6) fins 210, or seven (7) fins 210) than eight fins 210 or more than (e.g., ten (10) fins 210, twelve (12) fins 210). A number of the fins 210 may depend, at least in part, on a diameter of the wellbore 204, such as a diameter of the casing 206. In some embodiments, the heat exchanger 200 includes at least eight (8) of the fins 210.

In some embodiments, an angle θ between circumferentially neighboring fins 210 may be within a range of from about 15° to about 90°, such as from about 15° to about 30°, from about 30° to about 45°, from about 45° to about 60°, from about 60° to about 75°, or from about 75° to about 90°.

In some embodiments, each of the fins 210 exhibits substantially the same size and shape as the other fins 210. For example, in some embodiments, each fin 210 may exhibit a substantially rectangular prism shape. In some embodiments, the fins 210 may be referred to as plates, slits, or slots that are cut out of the formation 202. In some embodiments, surfaces of the formation 202 defining the fins 210 may be substantially planar. In other embodiments, at least one of the fins 210 exhibits a different size than at least another of the fins 210.

A height H of the fins 210 may be within a range of from about 100 meters to about 1,500 meters, such as from about 100 meters to about 250 meters, from about 250 meters to about 500 meters, from about 500 meters to about 750 meters, from about 750 meters to about 1,000 meters, from about 1,000 meters to about 1,250 meters, or from about 1,250 meters to about 1,500 meters. In some embodiments, the height H of the fins 210 is within a range of from about 200 meters to about 600 meters. In some embodiments, the height H of the fins 210 is within a range of from about 500 meters to about 1,000 meters. In some embodiments, the height H of the fins 210 is about 1,000 meters. Since the height H of the fins 210 refers to the vertical dimension of the fins 210 extending into the formation 202, the height H may also be referred to herein as the “depth” of the fins 210.

A length L of the fins 210 (e.g., in the radial direction relative to the wellbore 204) may be within a range of from about 10 meters to about 100 meters, such as from about 10 meters to about 25 meters, from about 25 meters to about 50 meters, from about 50 meters to about 75 meters, or from about 75 meters to about 100 meters. In some embodiments, the length L of the fins 210 is within a range of from about 25 meters to about 50 meters. In some embodiments, the length L of the fins 210 is within a range of from about 10 meters to about 20 meters.

In some embodiments, a ratio of the height H of the fins 210 to the length L of the fins 210 is within a range of from about 1:1 to about 150:1, such as from about 1:1 to about 10:1, from about 10:1 to about 20:1, from about 20:1 to about 50:1, from about 50:1 to about 100:1, or from about 100:1 to about 150:1. In some embodiments, the vertical depth of the fins 210 into the formation 202 is greater than a radial length L of the fins 210 into the formation 202.

A thickness T of the fins 210 (e.g., in a direction substantially perpendicular to each of the height H and the length L of the fins 210) may be within a range of from about 10 mm to about 100 mm, such as from about 10 mm to about 25 mm, from about 25 mm to about 50 mm, from about 50 mm to about 75 mm, or from about 75 mm to about 100 mm. In some embodiments, the thickness T is within a range of from about 25 mm to about 75 mm. In some embodiments, the thickness T is about 50 mm.

A volume of each of the fins 210 may be within a range of from about 100 cubic meters (m³) to about 20,000 m³, such as from about 100 m³ to about 1,000 m³, from about 1,000 m³ to about 5,000 m³, from about 5,000 m³ to about 10,000 m³, from about 10,000 m³ to about 15,000 m³, or from about 15,000 m³ to about 20,000 m³. In some embodiments, the volume of each of the fins 210 is within a range of from about 10,000 m³ to about 20,000 m³. However, the disclosure is not so limited, and the volume of each of the fins 210 may be different than that described above. In some embodiments, each fin 210 exhibits substantially the same volume. In other embodiments, at least one of the fins 210 exhibits a different volume than at least another of the fins 210.

In some embodiments, the heat exchanger 200 (e.g., the fins 210) may be sized and shaped to facilitate a desired residence time of the second fluid 108 within the formation 202 for a given flowrate of the second fluid 108. By way of non-limiting example, the heat exchanger 200 may be sized and shaped to store a volume of the second fluid 108 within a range sufficient to generate from about 500 hours to about 1,500 hours of power when the power generation system 120 (FIG. 1) is operated at baseload capacity (e.g., from about 10 MW to about 50 MW), such as from about 500 hours to about 1,000 hours, or from about 1,000 hours to about 1,500 hours.

A residence time of the second fluid 108 in the heat exchanger 200 is within a range of from about 1 day to about 30 days, such as from about 1 day to about 2 days, from about 2 days to about 5 days, from about 5 days to about 10 days, from about 10 days to about 15 days, from about 15 days to about 20 days, or from about 20 days to about 30 days.

In some embodiments, a volume of the heat exchanger 200 (e.g., a volume defined by the fins 210) may be substantially larger than a volume of the second fluid 108 entering the heat exchanger 200 over a given duration, such as over a duration of about 1 hour, about 6 hours, about 12 hours, about 1 day, about 5 days, about 10 days, or even about 1 month. Accordingly, in some embodiments, the heat exchanger 200 may be sized and shaped such that the temperature of the second fluid 108 exiting the heat exchanger 200 is relatively stable. In other words, the relatively large volume defined by the fins 210 relative to the volume of the second fluid 108 flowing through the heat exchanger 200 over a duration (e.g., the volume of the fins 210 relative to the residence time of the second fluid 108 within the heat exchanger 200) may facilitate maintaining the temperature of the second fluid 108 exiting the heat exchanger 200 at a relatively stable temperature. In some such embodiments, the formation 202 may comprise a so-called heat sink configured to equilibrate the temperature of the second fluid 108.

In some embodiments, the size of the fins 210 may facilitate a flow of the second fluid 108 through the formation 202 with a relatively low pressure drop as the second fluid 108 flows from the casing 206 to the fins 210 and from the fins 210 to the tubular member 208. By way of comparison, enhanced geothermal systems (EGS) for removal of thermal energy from a formation may be configured to transfer heat between a fluid and the formation through fractures (e.g., perforations) in the formation. The relatively narrow size of the fractures in conventional enhanced geothermal systems increases a pressure drop of the fluid as the fluid is moved through the formation and to the surface of the Earth. By way of contract, the fins 210 of the heat exchanger 200 according to embodiments of the disclosure may be sized and shaped based on the desired pressure drop of the second fluid 108 through the heat exchanger 200 and on a desired amount of thermal energy desired to be stored within the heat exchanger 200.

In use and operation, the second fluid 108 is introduced to the wellbore 204 through the casing 206 (e.g., through the channels 212 of the casing 206). A direction of the flow of the second fluid 108 is indicated by arrows 220. The second fluid 108 flows through the channels 212 and exits the casing 206 to the fins 210. The second fluid 108 flows (e.g., by gravity) through the fins 210 and exchanges heat with the formation 202 through the fins 210. At the bottom of the wellbore 204, the second fluid 108 may enter the tubular member 208 where the second fluid 108 flows countercurrent to the direction of flow of the second fluid 108 through the fins 210. For example, the second fluid 108 in the tubular member 208 may flow upwards (e.g., against the direction of gravity) while the second fluid 108 in the fins 210 travels downwards through the formation 202.

In some embodiments, the temperature of the second fluid 108 may be within a range of from about 150° C. to about 300° C., such as from about 150° C. to about 200° C., from about 200° C. to about 250° C., or from about 250° C. to about 300° C.

Since the heat exchanger 200 is configured to generate the second fluid 108 having a relatively stable temperature leaving the wellbore 204, the second fluid 108 may be used to transfer heat to the third fluid 122 of the power generation system 120 (FIG. 1) to generate power at a relatively stable rate (e.g., at a baseload rate). Accordingly, the heat exchanger 200 may facilitate generation of a baseload power by the system 100 that meets the demands of current power demand, despite daily and seasonal variations in power generated by a renewable energy source (e.g., the source 102). In some embodiments, the heat exchanger 200 may be used to increase the amount of renewable energy that may be used to supply baseload power requirements to the electrical grid without disturbing the electrical grid since the heat exchanger 200 provides a constant flow of thermal energy to the power generation system 120. Accordingly, renewable energy sources may be used without operating the electrical grid associated with the system 100 in so-called load-following mode wherein power generation is adjusted as demand for electricity fluctuates throughout the day. Conventional load-following operation may reduce power generation efficiency from increased cycling and/or the use of less efficient natural gas peaking plants.

Accordingly, in some embodiments, the system 100 may be configured to provide power at a required baseload capacity (e.g., sufficient to meet energy demand) and provide sufficient rotational inertia (e.g., to a generator, such as the power generation system 120) to stabilize an electrical grid. The system 100 may facilitate storage of energy within the formation 202 during times of excess power generation or availability. In addition, the system 100 may not occupy a large footprint and may exhibit a negligible environmental impact.

While embodiments of the disclosure may be susceptible to various modifications and alternative forms, specific embodiments have been shown by way of example in the drawings and have been described in detail herein. However, it should be understood that the disclosure is not limited to the particular forms disclosed. Rather, the disclosure encompasses all modifications, variations, combinations, and alternatives falling within the scope of the disclosure as defined by the following appended claims and their legal equivalents.

What is claimed is:

1. A system power generation from renewable energy, the system comprising: a heat exchanger in a subterranean formation, the heat exchanger comprising:
a casing at an upper portion of a wellbore;
a tubular member extending through the casing to a lower portion of the wellbore; and
fins in fluid communication with the casing and with the tubular member, each of the fins comprising a volume defined by surfaces of the subterranean formation and configured to receive a fluid from the casing.

2. The system of claim 1, further comprising a power generation system including a fluid configured to transfer heat with the fluid of the heat exchanger operably coupled to the tubular member.

3. The system of claim 2, wherein the power generation system comprises a concentrated solar power (CSP) farm or a wind power plant.

4. The system of claim 1, wherein the casing comprises channels, each channel fluidly coupled to a fin.

5. The system of claim 1, wherein a depth of the fins into the subterranean formation is within a range of from about 500 meters to about 1,000 meters.

6. The system of claim 1, wherein the fluid in the tubular member is configured to flow countercurrent to the fluid in the fins.

7. The system of claim 1, wherein the heat exchanger comprises at least eight fins.

8. The system of claim 1, wherein the fluid comprises water.

9. The system of claim 1, wherein the fins exhibit a plate shape.

10. The system of claim 1, wherein the fins extend from the casing in a radial direction.

11. The system of claim 1, wherein an angle between circumferentially neighboring fins is within a range of from about 45° to about 60°.

12. A longitudinal finned heat exchanger, comprising:
a casing including one or more channels extending therethrough, the one or more channels configured to receive a fluid from above a surface of the Earth;
a tubular member vertically extending through the casing and through a subterranean formation; and
longitudinal fins extending through the subterranean formation, an upper portion of each longitudinal fin of the longitudinal fins in fluid communication with a channel of the one or more channels of the casing and a lower portion of each longitudinal fin of the longitudinal fins in fluid communication with the tubular member, each longitudinal fin of the longitudinal fins defined by surfaces of the subterranean formation.

13. The longitudinal finned heat exchanger of claim 12, wherein a volume of each longitudinal fin of the longitudinal fins is within a range of from about 10,000 m³ to about 20,000 m³.

14. The longitudinal finned heat exchanger of claim 12, wherein each of the fins exhibits a plate shape.

15. The longitudinal finned heat exchanger of claim 12, wherein a depth of each longitudinal fin of the longitudinal fins vertically into the subterranean formation is greater than a radial length of the respective longitudinal fin.

16. A method of storing thermal energy within a subterranean formation, the method comprising:
flowing a fluid from a source to a heat exchanger within a subterranean formation, the heat exchanger comprising:
a plurality of fins extending through the subterranean formation, each fin defined by surfaces of the subterranean formation and defining an open volume configured for flowing another fluid within the heat exchanger; and
transferring heat between the another fluid within the fins and the subterranean formation.

17. The method of claim 16, wherein transferring heat between the another fluid within the fins and the subterranean formation comprises transferring heat from the subterranean formation to the another fluid.

18. The method of claim 16, wherein transferring heat between the another fluid within the fins and the subterranean formation comprises flowing the another fluid through the subterranean formation such that a residence time of the another fluid within the subterranean formation is within a range of from about 1 day to about 30 days.

19. The method of claim 16, further comprising, after transferring heat between the another fluid within the fins and the subterranean formation, transferring heat from the another fluid to an additional fluid configured to generate power.

20. The method of claim 16, wherein flowing a fluid from a source to a heat exchanger comprises flowing a fluid from a source comprising a renewable energy source to the heat exchanger.
